(19) United States
(12) Patent Application Publication
(10) Pub. No.: US 2025/0150846 A1
(43) Pub. Date: May 8, 2025

(54) MILLIMETER WAVE (mmWave) LINK BEAM FAILURE RECOVERY

(71) Applicant: NXP USA, Inc., AUSTIN, TX (US)

(72) Inventors: Xiayu Zheng, San Jose, CA (US); Liwen Chu, San Ramon, CA (US); Hongyuan Zhang, Fremont, CA (US); Rui Cao, Sunnyvale, CA (US)

(21) Appl. No.: 18/940,223

(22) Filed: Nov. 7, 2024

Related U.S. Application Data
(60) Provisional application No. 63/596,972, filed on Nov. 8, 2023.

(51) Int. Cl. H04W 16/28; H04W 16/18; H04W 88/10

(52) U.S. Cl. CPC H04W 16/28; H04W 16/18; H04W 88/10

(57) ABSTRACT

Methods and apparatus are described for millimeter wave (mmWave) link beam failure recovery. A wireless multi-link device (MLD), such as a non-AP MLD, establishes mmWave link and a non-mmWave link with a second wireless MLD. Upon detecting a beam failure of the mmWave link, the wireless MLD transmits, via the non-mmWave link, an indication of the beam failure which may also include a request frame for a candidate beam training procedure to be initiated by the second wireless MLD. In response, the wireless MLD receives, via the mmWave link, candidate beam training packets from the second wireless MLD. The wireless MLD further transmits, via the non-mmWave link, beam training feedback information regarding the candidate beam training packets. In an example, a new Tx beam (e.g., a Tx beam with a highest received signal strength) is selected for maintaining the mmWave link.

### CROSS REFERENCE TO RELATED APPLICATIONS

The present U.S. Utility Patent Application claims priority pursuant to 35 U.S.C. § 119(e) to U.S. Provisional Application No. 63/596,972, entitled “mmWave LINK BEAM FAILURE RECOVERY PROCEDURE”, filed Nov. 8, 2023, which is hereby incorporated herein by reference in its entirety and made part of the present U.S. Utility Patent Application for all purposes.

### BACKGROUND OF THE INVENTION

### Field of the Invention

This disclosure relates generally wireless communications, and more specifically to beam failure recovery for a millimeter wave link.

Description of Related Art

Wireless local area networks (WLANs) have evolved rapidly over the past couple of decades, including WLANs that conform to the Institute of Electrical and Electronics Engineers (IEEE) 802.11 family of standards. A typical 802.11-based WLAN may be formed by one or more access points (APs) that provide a shared wireless communication medium for servicing a number of client devices or stations (STAs). In particular, an AP manages a Basic Service Set (BSS) that is identified by a Basic Service Set Identifier (BSSID) advertised by the AP.

More recently, the 802.11be amendment to the IEEE 802.11 standard (“Wi-Fi 7”) has added support for Multi-Link Operation (MLO). This feature increases capacity by simultaneously sending and receiving data across different frequency bands and channels (e.g., 2.4 GHz, 5 GHz, and 6 GHz). With MLO, for example, an access point multi-link (AP MLD) simultaneously establishes multiple links with a non-AP MLD client over more than one frequency band in order to increases throughput, reduce latency, and improve reliability. Multi-Link Operation also supports various operating modes. In a Simultaneous Transmit and Receive (STR) mode, for example, two or more links work independently of each other. In a Nonsimultaneous Transmit and Receive (NSTR) mode, simultaneous receiving and transmitting operations are not allowed, such that at a single time all links only receive data or all links only send data. MLO further enables packet-level link aggregation in the MAC layer across different PHY links.

### BRIEF DESCRIPTION OF THE DRAWINGS

One or more embodiments will now be described by way of example only with reference to the accompanying drawings, in which:

FIG. 1 illustrates an example of a multi-link communications system in accordance with embodiments of the present disclosure;

FIG. 2A illustrates an example of a frame exchange sequence for a mmWave link beam recovery procedure in accordance with an embodiment of the present disclosure;

FIG. 2B illustrates another example of a frame exchange sequence for a mmWave link beam recovery procedure in accordance with an embodiment of the present disclosure;

FIG. 2C illustrates another example of a frame exchange sequence for a mmWave link beam recovery procedure in accordance with an embodiment of the present disclosure;

FIG. 3 illustrates examples of mm Wave link beam failure detection in accordance with embodiments of the present disclosure;

FIG. 4 illustrates an example of a frame exchange sequence for switching from a mm Wave link to a non-mmWave link in accordance with an embodiment of the present disclosure;

FIG. 5A illustrates an example of a frame exchange sequence for a candidate beam training procedure for recovering a mm Wave link in accordance with an embodiment of the present disclosure;

FIG. 5B illustrates another example of a frame exchange sequence for a candidate beam training procedure for recovering a mmWave link in accordance with an embodiment of the present disclosure;

FIG. 6 illustrates an example of a frame exchange sequence of a mmWave sector sweep initiated by a non-mmWave link in accordance with an embodiment of the present disclosure;

FIG. 7 is a logic diagram illustrating an example process for mmWave link beam recovery in accordance with embodiments of the present disclosure; and

FIG. 8 illustrates an example of wireless multi-link device according to an embodiment of the present disclosure.

### DETAILED DESCRIPTION

The various implementations described in the following description relate generally to millimeter wave (mmWave) and non-mmWave communications to support new wireless communication protocols, and more particularly to mmWave link beam failure recovery procedures that support multi-link wireless communication features associated with the IEEE 802.11bn amendment (also referred to as Ultra High Reliability or “UHR” or “Wi-Fi 8”), and future generations, of the IEEE 802.11 standard. In some aspects, a mmWave link beam failure recovery procedure includes detecting a beam failure in a mmWave link between two wireless MLDs. The wireless MLD detecting the failure notifies the other MLD via a non-mmWave link and requests a candidate beam training procedure to identify a new Tx/Rx beam pair for maintaining or reestablishing the mmWave link. Beam training feedback information regarding candidate beams is also provided to the other MLD via the non-mmWave link.

As used herein, the term “non-legacy” may refer to frame structures, physical layer (PHY) protocol data unit (PPDU) formats and communication protocols conforming with the IEEE 802.11bn amendment to the IEEE 802.11 standard (“802.11bn”) as well as future generations/amendments. In contrast, the term “legacy” may be used herein to refer to frame structures, PPDU formats and communication protocols conforming to the IEEE 802.11be (also referred to as Extremely High Throughput or “EHT” or “Wi-Fi 7”) or IEEE 802.11ax (also referred to as High Efficiency or “HE” or “Wi-Fi 6/6E”) amendments to the IEEE 802.11 standard, or earlier generations of the IEEE 802.11 standard, but not conforming to all mandatory features of 802.11bn or future generations of the IEEE 802.11 standard.

Particular implementations of the subject matter described in the present disclosure can be implemented to realize one or more of the following potential advantages. By enabling recovery of a beam failure in a mmWave link, aspects of the described subject matter may support significantly gains in data throughput achievable in accordance with the mmWave and Multi-Link Operation (MLO) features of the IEEE 802.11bn amendment of the IEEE 802.11 standard. Among other examples, the described implementations facilitate recovery of mmWave links that can be used to provide load balancing according to traffic requirements, lower latency for enhanced reliability in a heavily loaded network, etc.

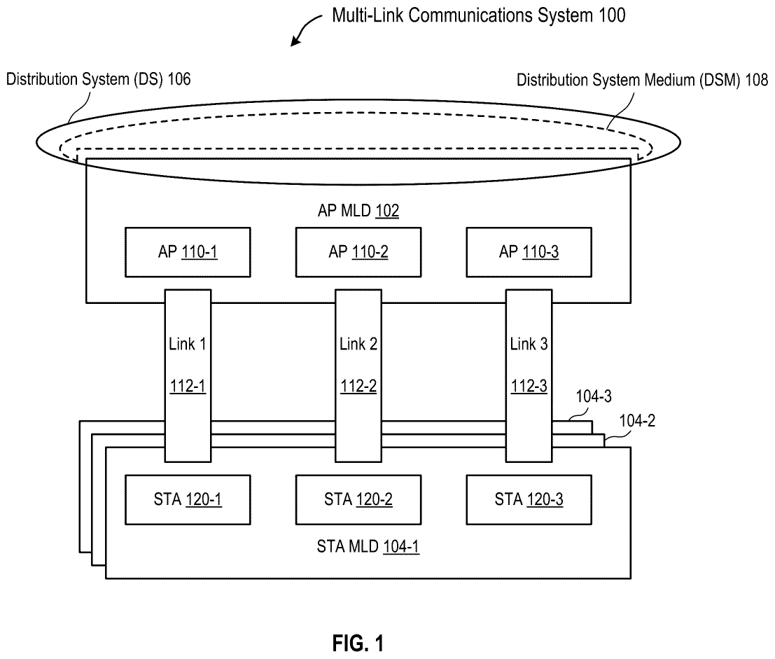

FIG. 1 illustrates an example of a multi-link (ML) communications system 100 in accordance with embodiments of the present disclosure. The illustrated multi-link communications system 100 includes at least one AP multi-link device (MLD) 102 and one or more non-AP multi-link devices, which are, for example, implemented as station (STA) MLDs 104-1, 104-2, and 104-3. The multi-link communications system 100 can be used in various applications, such as industrial applications, medical applications, computer applications, and/or consumer or appliance applications. In the illustrated example, the multi-link communications system is a wireless communications system compatible with an IEEE 802.11 standard. Although the depicted multi-link communications system 100 is shown in FIG. 1 with certain components and described with certain functionality herein, other embodiments of the multi-link communications system 100 may include fewer or more components to implement the same, less, or more functionality. For example, although the multi-link communications system 100 shown in FIG. 1 includes the AP MLD 102 and the STA MLDs 104-1, 104-2, and 104-3, in other embodiments, the multi-link communications system includes other multi-link devices, such as, multiple AP MLDs and multiple STA MLDs, multiple AP MLDs and a single STA MLD, a single AP MLD and a single STA MLD. In another example, the multi-link communications system includes more than three STA MLDs and/or less than three STA MLDs. In yet another example, although the multi-link communications system 100 is shown in FIG. 1 as being connected in a certain topology, the network topology of the multi-link communications system 100 is not limited to the topology shown in FIG. 1.

In the embodiment depicted in FIG. 1, the AP MLD 102 includes multiple radios, implemented as APs 110-1, 110-2, and 110-3. In some embodiments, the AP MLD 102 is an AP multi-link logical device or an AP multi-link logical entity (MLLE). In some embodiments, a common part of the AP MLD 102 implements upper layer Media Access Control (MAC) functionalities (e.g., beaconing, association establishment, reordering of frames, etc.) and a link specific part of the AP MLD 102, i.e., the APs 110-1, 110-2, and 110-3, implement lower layer MAC functionalities (e.g., backoff, frame transmission, frame reception, etc.). The APs 110-1, 110-2, and 110-3 may be implemented in hardware (e.g., circuits), software, firmware, or a combination thereof. At least one of the APs 110-1, 110-2, or 110-3 may be fully or partially implemented as an integrated circuit (IC) device. In some embodiments, the AP MLD and its affiliated APs 110-1, 110-2, and 110-3 are compatible with at least one WLAN communications standard (e.g., at least one IEEE 802.11 standard). For example, the APs 110-1, 110-2, and 110-3 may be wireless APs compatible with at least one non-legacy IEEE 802.11 standard.

In some embodiments, an AP MLD (e.g., the AP MLD 102) is connected to a local network (e.g., a local area network (LAN)) and/or to a backbone network (e.g., the Internet) through a wired connection and wirelessly connects to wireless STA MLDs, for example, through one or more WLAN communications standards, such as an IEEE 802.11 standard. In some embodiments, an AP (e.g., the AP 110-1, the AP 110-2, and/or the AP 110-3) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. The at least one controller may be implemented within a processor, such as a microcontroller, a host processor, a host, a digital signal processor (DSP), processing module, or a central processing unit (CPU), which can be integrated in a corresponding transceiver.

Each of the APs 110-1, 110-2, and 110-3 of the AP MLD 104 may operate in different frequency bands. For example, at least one of the APs 110-1, 110-2, or 110-3 of the AP MLD 104 operates in an Extremely High Frequency (EHF) band or the “millimeter wave (mmWave)” frequency band. In some embodiments, the mmWave frequency band is a band of radio wave frequencies between 30 Gigahertz (GHz) and 300 GHz. For example, a mm Wave link may operate in a 45 GHz or 60 GHz frequency band. In a specific example, the AP 110-1 may operate in a 6 GHz band (e.g., with a 320 MHz Basic Service Set (BSS) operating channel or other suitable BSS operating channel), the AP 110-2 may operate in a 5 GHz band (e.g., with a 160 MHz BSS operating channel or other suitable BSS operating channel), and the AP 110-3 may operate in a 60 GHz band (e.g., with a 160 MHz BSS operating channel or other suitable BSS operating channel).

In the illustrated embodiment, the AP MLD is connected to a distribution system (DS) 106 through a distribution system medium (DSM) 108. The distribution system (DS) 106 may be a wired network or a wireless network that is connected to a backbone network such as the Internet. The DSM 108 may be a wired medium (e.g., Ethernet cables, telephone network cables, or fiber optic cables) or a wireless medium (e.g., infrared, broadcast radio, cellular radio, or microwaves). Although the AP MLD 102 is shown in FIG. 1 as including three APs, other embodiments of the AP MLD 102 may include fewer than three APs or more than three APs. In addition, although some examples of the DSM 108 are described, the DSM 108 is not limited to the examples described herein.

In the embodiment depicted in FIG. 1, the STA MLD 104-1 includes radios, which are implemented as multiple non-AP stations (STAs) 120-1, 120-2, and 120-3. The STAs 120-1, 120-2, and 120-3 may be implemented in hardware (e.g., circuits), software, firmware, or a combination thereof. At least one of the STAs 120-1, 120-2, and 120-3 may be fully or partially implemented as an IC device. In some embodiments, the non-AP STAs 120-1, 120-2, and 120-3 are part of the STA MLD 104-1, such that the STA MLD may be a communications device that wirelessly connects to an AP MLD, such as, the AP MLD 102. For example, the STA MLD 104-1 (e.g., at least one of the non-AP STAs 120-1, 120-2 or 120-3) may be implemented in a laptop, a desktop personal computer (PC), a mobile phone, or other communications device that supports at least one WLAN communications standard. In some embodiments, the STA MLD and its affiliated STAs 120-1, 120-2, and 120-3 are compatible with at least one IEEE 802.11 standard. In an example, each of the non-AP STAs 120-1, 120-2, and 120-3 includes at least one antenna, at least one transceiver operably connected to the at least one antenna, and at least one controller connected to the corresponding transceiver. The at least one transceiver may include a PHY device. The at least one controller can be configured to control the at least one transceiver to process received packets through the at least one antenna. In some embodiments, the at least one controller is implemented by a processor, such as a microcontroller, a host processor, a host, a DSP, processing module, or a CPU, which can be integrated in a corresponding transceiver. In an example, the STA MLD has one MAC data service interface. In another example, a single address is associated with the MAC data service interface and is used to communicate on the DSM 108. In some embodiments, the STA MLD 104-1 implements a common MAC data service interface and the non-AP STAs 120-1, 120-2, and 120-3 implement a lower layer MAC data service interface.

In an example, the AP MLD 102 and/or the STA MLDs 104-1, 104-2, and 104-3 identify which communications links support the multi-link operation during a multi-link operation setup phase and/or exchanges information regarding multi-link capabilities during the multi-link operation setup phase. In addition, each of the STAs 120-1, 120-2, and 120-3 of the STA MLD may operate in a different frequency band. For example, at least one of the STAs 120-1, 120-2, or 120-3 of the STA MLD 104-1 operates in the mmWave frequency band (e.g., a 45 GHz or 60 GHz frequency band). In an example, the STA 120-1 may operate in a 6 GHz band (e.g., with a 320 MHz BSS operating channel or other suitable BSS operating channel), the STA 120-2 may operate in a 5 GHz band (e.g., with a 160 MHz BSS operating channel or other suitable BSS operating channel), and the STA 120-3 may operate in a 60 GHz band (e.g., with a 640 MHz BSS operating channel or other suitable BSS operating channel). Although the STA MLD 104-1 is shown in FIG. 1 as including three non-AP STAs, other embodiments of the STA MLD 104-1 may include fewer than three non-AP STAs or more than three non-AP STAs.

Each of the MLDs 104-2, 104-3 may be the same as or similar to the MLD 104-1. For example, the MLD 104-2 and 104-3 include one or multiple non-AP STAs. In some embodiments, each of the non-AP STAs includes at least one antenna, at least one transceiver operably connected to the at least one antenna, and at least one controller connected to the corresponding transceiver. In some embodiments, the at least one transceiver includes a PHY device. The at least one controller can be configured to control the at least one transceiver to process received packets through the at least one antenna. In some embodiments, the at least one controller is implemented by a processor, such as a microcontroller, a host processor, a host, a DSP, a processing module, or a CPU, which can be integrated in a corresponding transceiver.

In the illustrated network, the STA MLD 104-1 communicates with the AP MLD 102 through multiple communications links 112-1, 112-2, and 112-3. For example, each of the STAs 120-1, 120-2, and 120-3 communicates with an AP 110-1, 110-2, or 110-3 through a corresponding wireless communications link 112-1, 112-2, or 112-3. Although the illustrated AP MLD 102 wirelessly communicates with the STA MLD 104-1 through multiple links 112-1, 112-2, and/or 112-3, in other embodiments, the AP MLD 102 may communicate with the STA MLD through more than three communications links or less three than communications links.

In the embodiment depicted in FIG. 1, the communications links 112-1, 112-2, and 112-3 between the AP MLD and the STA MLD 104-1 involve at least one mmWave link. For example, the communications links 112-1, 112-2, and 112-3 between the AP MLD 102 and the STA MLD 104-1 include a mmWave link (e.g., a 45/60 GHz link) between an AP of the AP MLD 102 and an STA of the STA MLD 104-1 operating in a mmWave frequency band (e.g., a 45/60 GHz frequency band) and two non-mmWave links (e.g., 2.4 GHz, 5 GHz, or 6 GHz links) and two mmWave links (e.g., a 45 GHz link and a 60 GHz link) between APs of the AP MLD 102 and STAs of the STA MLD 104-1 operating in non-mmWave frequency bands (e.g., 2.4 GHz, 5 GHz, or 6 GHz frequency bands). In another example, the communications links 112-1, 112-2, and 112-3 between the AP MLD 102 and the STA MLD 104-1 include two mmWave links (e.g., 45/60 GHz links) between APs of the AP MLD 102 and STAs of the STA MLD 104-1 operating in mm Wave frequency bands (e.g., 45/60 GHz frequency bands) and one non-mmWave link (e.g., a 2.4 GHz, 5 GHz, or 6 GHz link) between an AP of the AP MLD 102 and an STA of the STA MLD 104-1 operating in a non-mmWave frequency bands (e.g., a 2.4 GHz, 5 GHz, or 6 GHz frequency band). The control and management of a mm Wave link, for example a 45 GHz/60 GHz link, may be performed in a non-mmWave link (e.g., a 2.4 GHz, 5 GHz, or 6 GHz link). For example, the association of a non-AP MLD with a mmWave link can be done through a non-mmWave MHz link.

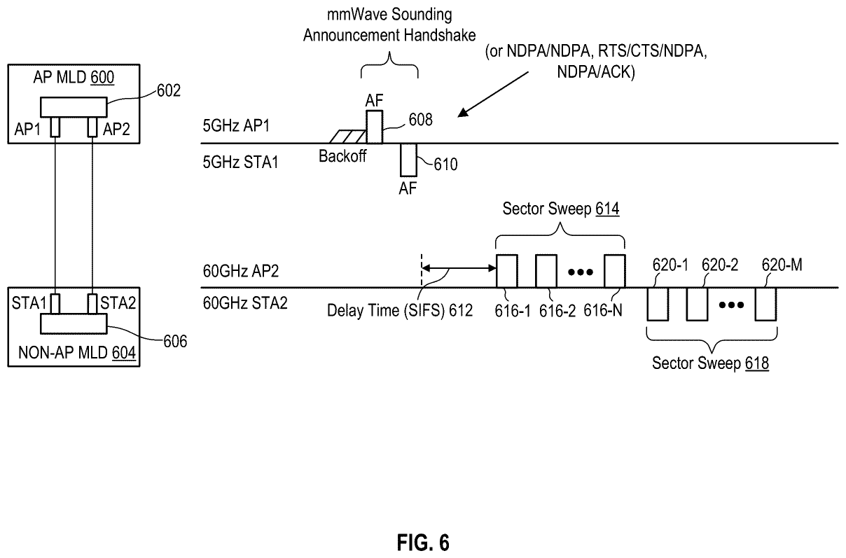

Under MLO, the control/management information for a mmWave link sounding procedure (or beam management procedure) to select a transmit (Tx) and receive (Rx) beam pair (or “Tx-Rx beam pair”) can be exchanged in a different ways. In an example, a control frame and ACK frame exchange (e.g., using one or more null data packet announcements (NDPAs) if the training PPDU is in NDP format, which may also be more generally referred to herein as an “announcement frame” without assumption of training PPDU format) is performed over a non-mmWave link to initiate and negotiate the sounding procedure. In this example, sector sweep (which may also be referred to as “sector level sweep” or “SLS”) PPDU measurements are performed over the mm Wave link, and sounding feedback information is exchanged over the non-mmWave link. Beam refinement procedures may also be utilized to improve the results of an initial sounding procedure or sector sweep. Examples of frame exchange sequences for (re)establishing a mmWave link are described in greater detail below with reference to FIG. 6.

Once established, however, a mmWave link between MLDs may suffer from beam failure (or possible beam failure) when there is a sudden deterioration in channel conditions. Channel deterioration can be caused, for example, by movement of one of the MLDs, obstacles that affect signal quality (e.g., physical objects in a line-of-site between the transceivers of the MLDs that may reflect or absorb wireless signals), other wireless signals in a shared wireless channel or in adjacent channels, etc. Such interference can vary over time and be difficult to predict. When a mmWave link deteriorates, a mmWave link beam recovery procedure such as described in the following embodiments can be employed to restore or improve the robustness of the link. The mmWave link beam recovery procedure may be initiated, for example, by a data packet recipient upon detecting a deteriorated mmWave link that has not completely failed.

In general, following detection of a deteriorated mmWave link, a recovery initiator may transmit a request frame to request a candidate beam training procedure, and a beam recovery responder may confirm the request frame with a response frame. In some examples, the request frame includes a request for a reverse direction candidate beam training procedure. A request frame to request a candidate beam training procedure may contain candidate Tx beam information for one or more candidate Tx beams. In an example, the candidate Tx beam information may be based on a previous BRP measurement report/feedback. If the response frame to a request frame is only transmitted for purposes of acknowledging the request frame, the response frame may be an ACK frame. In another example, the response frame may further include a request for a reverse direction candidate beam training procedure, and the response frame may also include candidate Tx beam information. If the response frame (if any) does not acknowledge the request frame, the beam recovery responder may not take any further actions (e.g., to send an announcement frame to initiate a candidate beam training procedure). In addition, in various embodiments the request frame and/or the response frame may be transmitted over either the mmWave link or the non-mmWave link. In an example, the request frame is sent via a non-mmWave link when the PPDU of a request frame might not be received over a mmWave link due to an asymmetry in DL/UL sensitivity and/or an omni-directional Rx beam at an AP MLD. In another example, the request frame is sent via a mmWave link when the PPDU of the request frame has sufficient sensitivity to be received by an AP MLD with an omni-directional Rx beam. Continuing with this example, the PPDU of the request frame may have a better associated sensitivity than a data traffic PPDU and/or a conservative beam failure detection threshold is utilized to detect link deterioration.

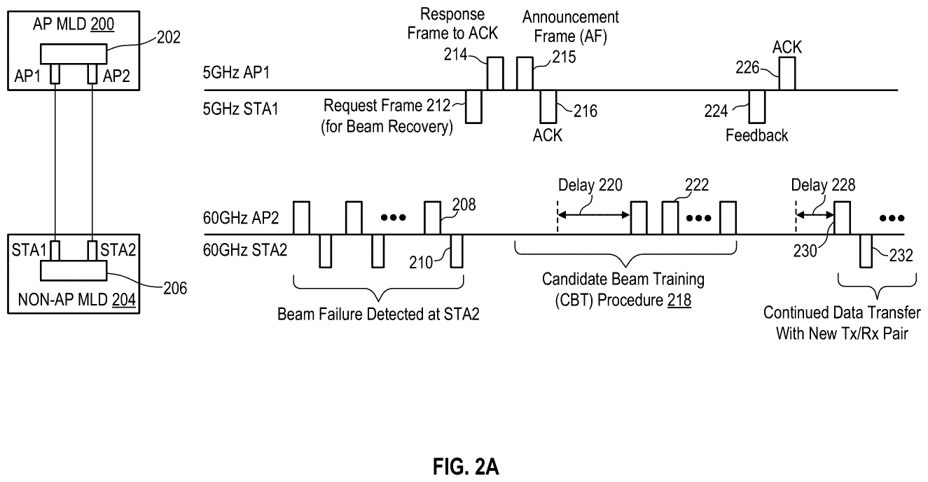

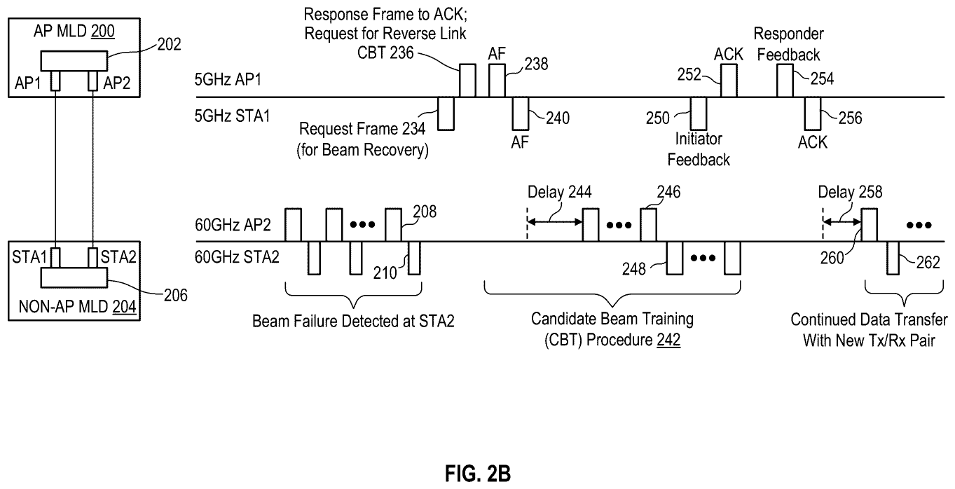

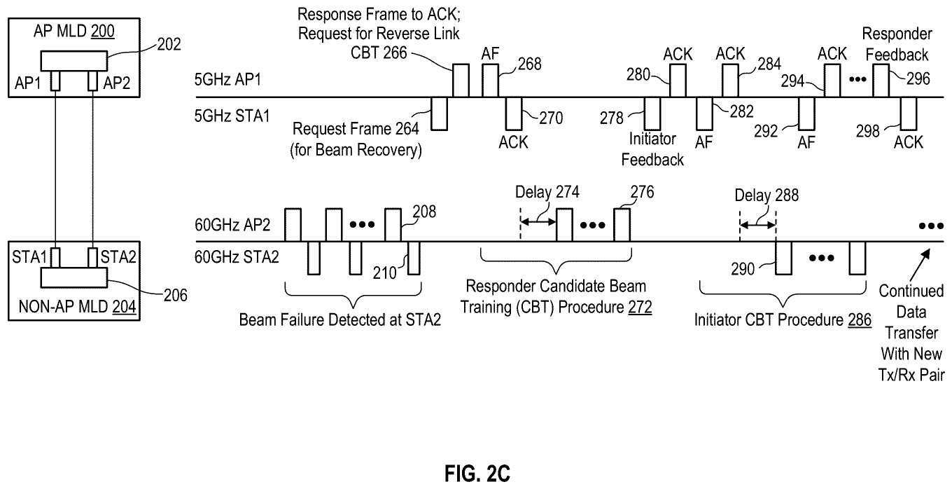

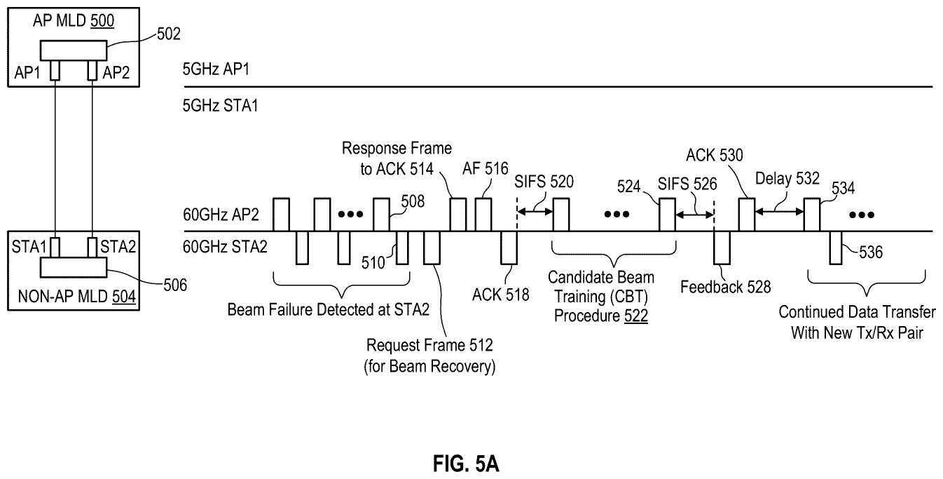

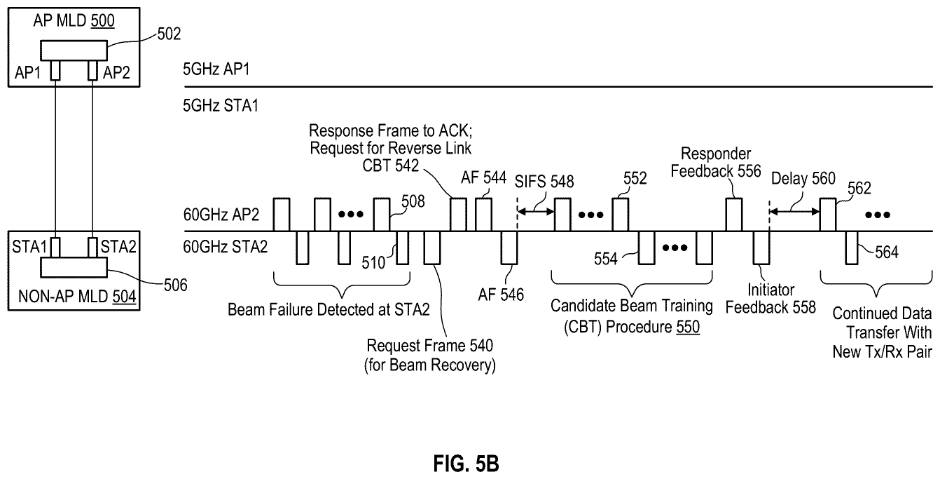

A candidate beam training (CBT) procedure according to various embodiments of the disclosure described herein consists of an announcement frame (AF), an acknowledgement (ACK) frame over a non-mm Wave link or mmWave link to set up the CBT, and a candidate beam training sequence at the mmWave link for beam measurement. In an example, the announcement frame and acknowledgement frame exchange occurs following the response frame from the beam recovery responder, and is conducted over the same link (mmWave or non-mmWave link) used for the request frame/response frame exchange. In another example, the acknowledgement frame is an announcement frame when a responder CBT procedure and an initiator CBT procedure are conducted sequentially (e.g., as illustrated in FIG. 2B and FIG. 5B). In yet another example, the response to an announcement frame is an ACK frame if a reverse direction CBT procedure is not needed (e.g., as illustrated in FIG. 2A) or if the reverse direction CBT is conducted separately (e.g., as illustrated in FIG. 2C).

In various examples, the AF and acknowledgement frame exchange can be used to negotiate parameters for a CBT procedure. For example, the AF and acknowledgement frame exchange may include detailed candidate Tx beam information (if not included in a request/response frame exchange), an indication that Rx beam training is needed and the number of Rx beams, other parameters related to training (TRN) fields of the candidate beam training packets to train the Tx and/or Rx beams, etc. In addition, when the AF and acknowledgement frame exchange is conducted over a mmWave link, the PPDU format that is utilized may differ from and have better sensitivity than the candidate beam training packets (which may also be referred to as “training PPDUs”). Further, the Tx beam information for the non-TRN fields of the candidate beam training packets may include a current best Tx/Rx beam pair for data traffic or, alternatively, may be exchanged via another control frame exchange that precedes the CBT sequence. The delay between the AF and acknowledgement frame exchange and the first of the candidate beam training packets may be either a pre-defined IFS (e.g., when the medium is available) or a medium access time with backoff.

With respect to the training PPDUs (i.e., candidate beam training packets), one or more novel formats may be utilized. In an example, the training PPDU may include additional Tx/Rx TRN fields, where the TRN fields have the same bandwidth as data PPDUs. In an example, the candidate beam information may be suggested by a receiver via a request/response frame exchange. In another example, the candidate beam information is determined by a transmitter via an AF/acknowledgement frame exchange. The PPDU format utilized for candidate beam training may vary (e.g., depending on channel conditions). In an example, a responder CBT procedure utilizes a training PPDU format that is similar to a beam refinement protocol (BRP) with additional Tx/Rx TRN fields appended to check the candidate Tx beams and further Rx beam training if required (otherwise, a corresponding best Rx beam from an earlier BRP training procedure may be utilized). The training PPDU may include, for example, pre-TRN fields/subfields, TRN fields: TXBeam1, TRN fields: TXBeam2, etc. The pre-TRN fields can be applied with a current best Tx beam and be received with the corresponding best Rx beam, as the packet can generally still be detected with this pair. In an example, the candidate Tx beams may be applied in a predefined pattern in the TRN fields such that the receiver (initiator) knows which Tx beam it uses and can apply the corresponding best available Rx beam for better reception over the TRN fields (e.g., the Tx Beam index in the training PPDU has a one-to-one mapping to the candidate beams recommended by the initiator, either in a request frame or by the responder in an announcement frame). In another example, the initiator CBT can also use the training PPDU format similar to a BRP format with Tx/Rx TRNs so long as the training PPDU can be detected with the current best Tx/Rx beam pair. Otherwise, the initiator CBT may utilize multiple AF/ACK exchanges in combination with single training PPDUs with directional-Rx for each candidate beam training (e.g., as illustrated in FIG. 2C). In this example, each training PPDU is applied with a single Tx beam but may still append TRN fields for further Rx beam training.

In various examples, initiator and/or responder beam training feedback (or “beam training feedback information”) may be transmitted over a non-mmWave link or a mmWave link to inform the transmitter of a best Tx beam to utilize for recovery of a mmWave link. Determining whether a non-mmWave link or a mmWave link is utilized may depend, for example, on the existence of a known Tx/Rx beam pair providing sufficient beamforming gain such that the beam training feedback and corresponding ACK frame(s) can be received on both sides of the mm Wave link. In an example, an initiator beam training feedback packet is transmitted in a similar manner as the request frame, which may depend on whether a sufficient Tx/Rx beam pair is known prior to transmission of the beam training feedback packet. A responder beam training feedback packet may be transmitted over the same link as an initiator beam training feedback packet, as the ACK frame has the same considerations as the request frame.

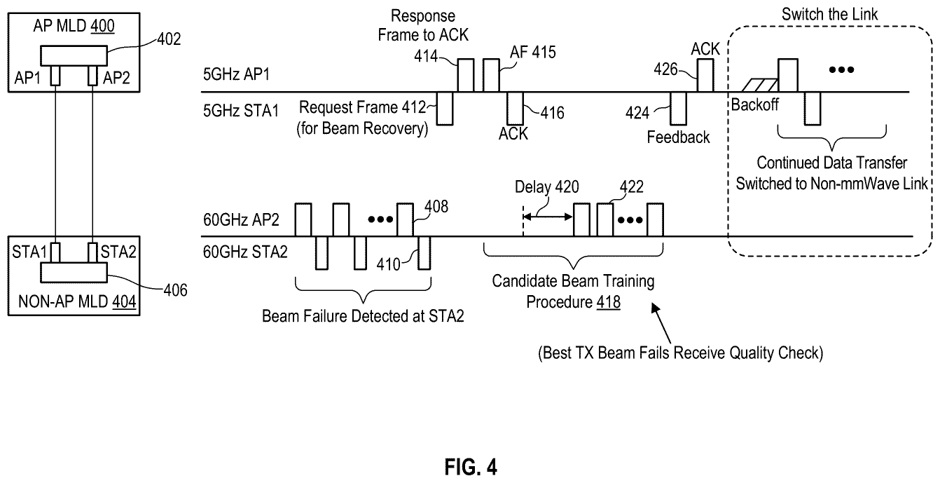

In a further example, a receiver of candidate beam training packets may have the option to compare a packet receive quality metric, e.g., receive signal strength indicator (RSSI), of the best candidate Tx beams with that of the current Tx/Rx beam pair or a pre-defined threshold. If one direction fails the receive quality check, the receiver of the corresponding candidate beam training packets can indicate (e.g., in a feedback frame) a suggestion to switch data transfer from a mmWave link to a more robust non-mmWave link (e.g., as illustrated in FIG. 4). Following such a switch, the AP MLD may initiate a regular sector level sweep and/or BRP procedure. Otherwise, the best identified candidate Tx beam is recommended as the new Tx beam for maintaining data traffic over the mmWave link.

FIG. 2A illustrates an example of a frame exchange sequence for a mmWave link beam recovery procedure in accordance with an embodiment of the present disclosure. In the illustrated example, frames are exchanged between an AP MLD 200, which includes a common MAC controller 202 and two wireless APs AP1 and AP2, and a non-AP MLD 204, which includes a common MAC controller 206 and two wireless STAs STA1 and STA2. In some embodiments, the common MAC controller 202 implements upper layer MAC functionalities (e.g., beaconing, association establishment, reordering of frames, etc.) of the AP MLD 200 and a link specific part of the AP MLD 200, e.g., AP1 and AP2, implements lower layer MAC functionalities (e.g., backoff, frame transmission, frame reception, etc.) of the AP MLD 200. In some embodiments, the common MAC controller 206 implements upper layer MAC functionalities (e.g., association establishment, reordering of frames, etc.) of the non-AP MLD 204 and a link specific part of the non-AP MLD 204, e.g., STA1 and STA2, implements lower layer MAC functionalities (e.g., backoff, frame transmission, frame reception, etc.) of the non-AP MLD 204. The AP MLD 200 depicted in FIG. 2A can be an embodiment of the AP MLD 102 depicted in FIG. 1 (however, the AP MLD 102 depicted in FIG. 1 is not limited to the embodiment shown in FIG. 2A). In addition, the non-AP MLD 204 depicted in FIG. 2A is an embodiment of the STA MLDs 104-1, 104-2, and 104-3 depicted in FIG. 1 (however, the STA MLDs 104-1, 104-2, and 104-3 depicted in FIG. 1 are not limited to the embodiment shown in FIG. 2A).

In the embodiment depicted in FIG. 2A, a mm Wave link (e.g., a 45 GHz link or a 60 GHz link) is established between AP2 and STA2, which both operate in a mmWave frequency band (e.g., a 45 GHz or 60 GHz frequency band) and are capable of mmWave communications, and a non-mmWave link (e.g., a 2.4/5/6 GHz band link) is established between AP1 and STA1, which both operate in a non-mm Wave frequency band (e.g., a 2.4 GHz, 5 GHz, or 6 GHz frequency band) and are capable of non-mmWave communications. Although the AP MLD 200 is shown in FIG. 2A as including two APs, other embodiments of the AP MLD 200 may include more than two APs. In addition, although the non-AP MLD 204 is shown in FIG. 2A as including two non-AP STAs, other embodiments of the non-AP MLD 204 may include more than two non-AP STAs.

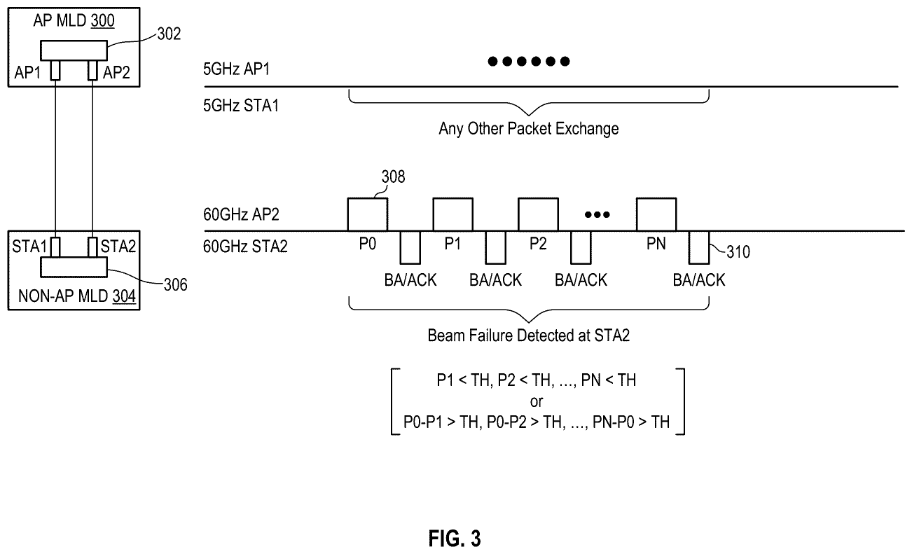

In the frame exchange sequence depicted in FIG. 2A, beam failure of the mmWave link (e.g., a 60 GHz link) is detected by the non-AP MLD 204/STA2. In an example, the AP2 transmits a plurality of data packets 208 (and/or control/management packets) to STA2 over the mmWave link. In this example, the STA2 transmits a BA/ACK 210 to AP2 over the mmWave link in response to each of the received data packets 208. The non-AP MLD 204 can detect a failure (or a possible/impending failure) of the mmWave link by analyzing the received data packets 208. In an example, the non-AP MLD 204 compares a received signal strength of each of the plurality of data packets 208 to a predetermined threshold, and identifies a mm Wave link beam failure when consecutive packets of the plurality of packets have a received signal strength that is less than the predetermined threshold. In another example, the non-AP MLD 204 determines that consecutive packets of the plurality of packets have a received signal strength, relative to a received signal strength of a preceding packet of the plurality of packets, that is less than the predetermined threshold. Further details of mmWave link beam failure detection are described below with reference to FIG. 3.

In response to detecting a beam failure for the mmWave link, the STA2 of this example transmits a request frame 212 to AP1 of the AP MLD 200 over the non-mmWave link in order to trigger a candidate beam training (CBT) procedure. In particular, the request frame 212 is configured to request a candidate beam training procedure 218 to be initiated by the AP MLD 200. In an example, the request frame 212 may include a subfield that indicates a beam failure, and is interpreted by the AP MLD 200 as a request for a candidate beam training procedure 218. In another example, the request frame 212 may include a dedicated subfield for explicitly requesting the candidate beam training procedure 218. In another example, the request frame 212 is a management frame, with no specific limitation on the PPDU format, that may be transmitted by either an AP MLD or non-AP MLD.

A response frame 214 is transmitted by AP1 to acknowledge the request frame 212. In an example, the response frame 214 is a management frame, with no specific limitation on the PPDU format, that may be transmitted by either an AP MLD or non-AP MLD. In the illustrated candidate beam training procedure 218, the response frame 214 is followed by an announcement frame (AF) 215 transmitted by AP1 of AP MLD 200 over the non-mmWave link. The announcement frame 215 is acknowledged by an acknowledgement frame (ACK) 216 transmitted by STA1 of non-AP MLD 204 over the non-mmWave link, followed by a candidate beam training procedure consisting of a plurality of packets 222 (e.g., “candidate beam training packets” or “sounding packets”) corresponding to different Tx beams of AP2. In an example, the AP2 transmits the plurality of packets 222 of the candidate beam training procedure following a delay 220 period of time. In a non-limiting example, the delay 220 could be either a pre-defined IFS or a medium access time with backoff. The candidate beam training parameters may be negotiated through the AF 215/ACK 216 exchange. For example, a number of Tx beams may be indicated by the AP1 in the AF 215. In another example, a number of Rx beams may be indicated by the STA1 in ACK 216 if Rx beam training for each AP2 transmit beam is needed (otherwise, the corresponding best beams can be used). In another example, the number of Tx beams and the number of Rx beams for candidate beam training may be advertised in respective mmWave link capabilities elements exchanged by the AP MLD 200 and non-AP MLD 204 (e.g., when the number of Tx or Rx beams is fixed). In an example, the PPDU format of the plurality of packets 222 includes Tx beam index information and/or sector ID information.

Although not separately illustrated in FIG. 2A, the candidate beam training procedure 218 may further include Tx beam training for STA2 and/or Rx beam training for AP2 (also referred to as “reverse direction candidate beam training” or “reverse link candidate beam training”) in which the STA2 transmits, over the mmWave link, a plurality of packets (e.g., candidate beam training packets/sounding packets corresponding to different candidate Tx beams) to the AP2. Examples of reverse direction candidate beam training are described more fully below with reference to FIG. 2B and FIG. 2C. In an example in which Rx beam training is not considered, the initial Rx beam for each Tx beam may be a Rx beam corresponding to the Tx beam as used in a previous sector sweep, beam refinement protocol (BRP) procedure, or other beam training procedure. In another example, the non-AP MLD 204 may select a Rx beam for use in the candidate beam training procedure 218. In yet another example, the number of Tx beams may be a subset of available Tx beams that is determined based on an earlier sector sweep/BRP procedure conducted by the AP MLD 200 and non-AP MLD 204.

Following the candidate beam training procedure 218, in the frame exchange sequence depicted in FIG. 2A the STA1 of the non-AP MLD 204 transmits beam training feedback information 224 regarding the candidate beam training packets over the non-mmWave link. The beam training feedback information 224 is acknowledged by an ACK 226 from AP1. In an example, the beam training feedback information 224 (e.g., a measurement result report) includes an indication of a Tx beam (of candidate Tx beams) with a highest received signal strength. The indicated Tx beam may then be used as a new Tx beam to reestablish the mmWave link. If beam training is also performed for the Rx beam, a new (or current) Rx beam is included as the new Tx/Rx beam pair. In the illustrated example, data transfer (e.g., an exchange of data and/or management/control packets 230 and BA/ACKs 232) can resume over the mmWave link following a negotiated delay time 228. In another example in which the candidate beam training procedure 218 is unsuccessful (such as described with reference to FIG. 4), data transfer can be switched from the mm Wave link to the non-mm Wave link.

In an embodiment, the non-AP MLD 204 can have the option of comparing the received signal strengths of the candidate beam training packets to a predetermined threshold to determine, for example, if the candidate beam training procedure is likely to result in a Tx/Rx beam pair that can be used to reestablish the mmWave link. In an example, the non-AP MLD 204 can identify one or more packets of the candidate beam training packets having a highest received signal strength (or RSSI level), which generally corresponds to the best candidate Tx beam. The highest received signal strength (or other receive quality metric) can then be compared to a predetermined threshold value to determine if the corresponding Tx beam may trigger another beam failure detection (e.g., when the same predetermined threshold value is used to detect an initial mmWave link beam failure as described with reference to FIG. 3).

Continuing with this example, if the highest received signal strength is above the predetermined threshold, the beam training feedback information 224 may identify the corresponding Tx beam as a preferred Tx beam. If the highest received signal strength compares unfavorably to the predetermined threshold, however, the beam training feedback information 224 may include a request to switch data transfer from the mm Wave link to the non-mmWave link. In an example, if the non-AP MLD 204 transmits a request to switch data transfer from the mmWave link to the non-mm Wave link, the AP MLD 200 may acknowledge the request and initiate a sector level sweep procedure to reestablish the mmWave link following the switch. In another example (not separately illustrated), if the non-AP MLD 204 transmits a request for another candidate beam training procedure, the AP MLD 200 may acknowledge the request and initiate a new candidate beam training procedure (e.g., following a delay after the end of the acknowledge frame). The request for another candidate beam training and/or the acknowledgement from the AP MLD 200 may be conditioned on support of multiple candidate beam sets or codebooks by the AP MLD 200 (e.g., as may be advertised in a mmWave link capability element).

In another example, a new Tx/Rx beam pair identified by the candidate training procedure 218 does not necessarily need to be the optimal Tx/Rx beam pair. Rather, the new Tx/Rx beam pair may result in sufficient beamforming gain/PHY rate such that the mmWave link can be quickly reestablished. In this example, a BRP procedure or tracking procedure can be utilized to further train the Tx/Rx beam pair of the mmWave link, and the new Tx/Rx beam pair from the candidate beam training procedure can be used as an input for a subsequent beam training procedure.

FIG. 2B illustrates another example of a frame exchange sequence for a mmWave link beam recovery procedure in accordance with an embodiment of the present disclosure. In the illustrated example, the AP MLD 200 and the non-AP MLD 204 correspond to the AP MLD 200 and the non-AP MLD 204 of FIG. 2A. In addition, the illustrated packet exchange sequence involving beam failure detection (data packets 208 and BAs/ACKs 210) proceed as described above with reference to FIG. 2A. In this example, the AP MLD 200 requests a sequential reverse link candidate beam training procedure (e.g., due to no Tx/Rx beam reciprocity and/or the reverse direction also has degradation).

In response to detecting a beam failure for the mmWave link, the STA2 of this example transmits a request frame 234 to AP1 of the AP MLD 200 over the non-mmWave link in order to trigger a candidate beam training procedure (CBT) 242 to be initiated by the AP MLD 200. A response frame 236 is transmitted by AP1 (over the non-mmWave link) to acknowledge the request frame 234 and, in this example, to request a sequential reverse link CBT procedure 242. The AP1 further transmits an announcement frame 238 for the CBT procedure 242, and the STA1 responds with an announcement frame 240 for the reverse link portion of the CBT procedure 242. In the CBT procedure 242 of this example, the AP2 transmits a plurality of candidate beam training packets 246 following a delay 244 period of time (e.g., a pre-defined IFS or a medium access time with backoff). Following the candidate beam training packets 246, the STA2 transmits a plurality of candidate beam training packets 248 for reception by the AP2 over the mmWave link.

In the frame exchange sequence depicted in FIG. 2B, the STA1 of the non-AP MLD 204 transmits initiator beam training feedback information 250, regarding the candidate beam training packets 246, over the non-mmWave link. The initiator beam training feedback information 250 is acknowledged by an ACK 252 from AP1. In addition, the AP1 transmits responder beam training feedback information 254 regarding the candidate beam training packets 248 over the non-mmWave link. The responder beam training feedback information is acknowledged by an ACK 256 from STA1. In the illustrated example, data transfer (e.g., an exchange of data and/or management/control packets 260 and BA/ACKs 262) can resume over the mmWave link following a negotiated delay time 258.

FIG. 2C illustrates another example of a frame exchange sequence for a mmWave link beam recovery procedure in accordance with an embodiment of the present disclosure. In the illustrated example, the AP MLD 200 and the non-AP MLD 204 correspond to the AP MLD 200 and the non-AP MLD 204 of FIG. 2A. In addition, the illustrated packet exchange sequence involving beam failure detection (data packets 208 and BAs/ACKs 210) proceed as described above with reference to FIG. 2A. In this example, the AP MLD 200 requests a non-sequential reverse link candidate beam training procedure (e.g., due to no Tx/Rx beam reciprocity and/or the reverse direction also has degradation).

In response to detecting a beam failure for the mmWave link, the STA2 of this example transmits a request frame 264 to AP1 of the AP MLD 200 over the non-mmWave link in order to trigger a candidate beam training procedure to be initiated by the AP MLD 200. A response frame 266 is transmitted by AP1 (over the non-mm Wave link) to acknowledge the request frame 264 and, in this example, to request a (non-sequential) reverse link CBT procedure. The AP1 further transmits an announcement frame 268 for the responder CBT procedure 272, and the STA1 responds with an ACK 270. In the responder CBT procedure 272 of this example, the AP2 transmits a plurality of candidate beam training packets 276 following a delay 274 period of time (e.g., a pre-defined IFS or a medium access time with backoff).

In the frame exchange sequence depicted in FIG. 2C, the STA1 of the non-AP MLD 204 transmits initiator beam training feedback information 278, regarding the candidate beam training packets 276, over the non-mmWave link. The initiator beam training feedback information 278 is acknowledged by an ACK 280 from AP1. In addition, the STA1 transmits an announcement frame 282 for an initiator candidate beam training procedure 286. In an example, the initiator candidate beam training procedure 286 includes a plurality of candidate beam training packets 290, each of which is transmitted following a delay 288 after an AF/ACK exchange. In the illustrated embodiment, each of the candidate training packets is transmitted following an AF 292/ACK 294 exchange over the non-mmWave link. In a specific example, each of the candidate beam training packets 290 is applied with a Tx beam with directional-Rx at the receiver. In this example, each training PPDU may append TRN fields for further Rx beam training. Single training PPDU following an AF/ACK exchange may be utilized, for example, if initiator candidate beam training packets cannot be easily detected using a current best Tx/Rx beam pair.

Following the candidate beam training procedure 286, the AP1 transmits responder beam training feedback information 296 regarding the candidate beam training packets 290 over the non-mmWave link. The responder beam training feedback information is acknowledged by an ACK 298 from STA1. In the illustrated example, data traffic can resume over the mmWave link following a negotiated delay time.

FIG. 3 depicts examples of mmWave link beam failure detection in accordance with embodiments of the present disclosure. In the illustrated examples, the AP MLD 300 and the non-AP MLD 304 correspond to the AP MLD 200 and the non-AP MLD 204 of FIG. 2A. In the frame exchange sequence depicted in FIG. 3, the AP2 of AP MLD 300 transmits a plurality of data packets 308 (and/or control/management packets) to STA2 of non-AP MLD 304 over the mmWave link. In this example, the STA2 transmits a BA/ACK 310 to AP2 over the mmWave link in response to each of the received data packets 308. The non-AP MLD 304 can detect a failure (or a possible/impending failure) of the mmWave link by analyzing the received data packets 308.

In a first example, the non-AP MLD 304 compares a received signal strength of each of the plurality of data packets 308 to a predetermined threshold, and identifies a mm Wave link beam failure for a Tx/Rx beam pair when consecutive packets of the plurality of data packets 308 have a received signal strength (e.g., RSSI level) that is less than the predetermined threshold. In a specific example, the non-AP MLD 304 identifies a mmWave link beam failure when a measured RSSI (Pi, i=0, 1 . . . , N) is lower than a predetermined/pre-configured threshold “TH” for a certain number N of consecutive data packets 308, such that P1<TH, P2<TH, . . . , PN<TH. In this example, a value of the predetermined threshold TH may be selected by assuming that a sufficient PHY rate could be achieved with that value of RSSI in the mmWave link.

In another example, the non-AP MLD 304 identifies a mmWave link beam failure for a Tx/Rx beam pair when consecutive packets of the plurality of data packets 308 have a received signal strength, relative to a received signal strength of a preceding packet of the plurality of packets (e.g., an RSSI drop or other applicable metric for receive signal quality), that is less than a predetermined threshold. In a specific example, the non-AP MLD identifies a mmWave link beam failure when a measured RSSI drop is greater than a predetermined/pre-configured threshold “TH” for a certain number N of consecutive data packets 308, such that P0−P1>TH, P0−P2>TH, . . . , PN−P0>TH. In the foregoing examples, the value of the predetermined threshold and the number N may be advertised in a beacon or other control/management frame transmitted over the non-mmWave link.

FIG. 4 illustrates an example of a frame exchange sequence for switching from a mm Wave link to a non-mm Wave link in accordance with an embodiment of the present disclosure. In the illustrated example, the AP MLD 400 and the non-AP MLD 404 correspond to the AP MLD 200 and the non-AP MLD 204 of FIG. 2A. In addition, the illustrated packet exchange sequence involving beam failure detection (data packets 408 and BAs/ACKs 410), beam recovery request frame 412 and response frame 414, and the candidate beam training procedure 418 (announcement frame 415, ACK 416, delay 420 and candidate beam training packets 422) proceed as described above with reference to FIG. 2A.

In the illustrated example, however, the best Tx beam identified by the candidate beam training procedure 418 fails a receive quality check such as described in conjunction with FIG. 3 (or the candidate beam training procedure 418 is otherwise determined to be unsuccessful). In an example, the STA1 of the non-AP MLD 404 transmits beam training feedback information 424 regarding the candidate beam training packets over the non-mmWave link. The beam training feedback information 424 may include an indication that the candidate beam training procedure 418 was not successful. Alternatively, the AP MLD 400 may analyze the beam training feedback information 424 to determine that the candidate beam training procedure 418 was not successful. The beam training feedback information 424 is acknowledged over the non-mmWave link by an ACK 426 from AP1. In an example, ACK 426 includes an indication to switch data transfer from the mmWave link to the non-mmWave link. In this example, continued data transfer is switched from the mm Wave link to the non-mmWave link following expiration of a backoff period (e.g., a backoff counter increments to zero).

FIG. 5A illustrates an example of a frame exchange sequence for a candidate beam training procedure for recovering a mm Wave link in accordance with an embodiment of the present disclosure. In the illustrated example, the AP MLD 500 and the non-AP MLD 504 correspond to the AP MLD 200 and the non-AP MLD 204 of FIG. 2A. In addition, the illustrated packet exchange sequence involving beam failure detection (data packets 508 and BAs/ACKs 510) proceed as described above with reference to FIG. 2A. In this example, the non-AP MLD 504 requests a candidate beam training procedure to be conducted over the mmWave link. In this example, the illustrated request, response and feedback exchange may be conducted over the mmWave link when the reverse direction in the mmWave link has sufficient sensitivity for the request frame PPDU (and the feedback or ACK uses the same type of PPDU, which may be different than the candidate beam training packet PPDUs) to be received with an omni-directional beam. In particular, a request frame PPDU having better associated sensitivity than the data traffic PPDUs can be used. In another example, a conservative beam failure detection threshold may have been utilized for beam failure detection. In addition, a reverse direction CBT is not requested in the illustrated example (e.g., due to Tx/Rx beam reciprocity or the mmWave link is relatively strong in the reverse direction).

In the illustrated example, the STA2 transmits a request frame 512 (for beam recovery) over the mmWave link, and a response frame 514 is transmitted by AP2 to acknowledge the request frame 514. The AP2 further transmits an announcement frame 516 for the CBT procedure 522, and the STA2 responds with an acknowledgement frame 518. In the CBT procedure 522 of this example, the AP2 transmits a plurality of candidate beam training packets 524 following a pre-defined IFS 520 (e.g., a short interframe space). The STA2 transmits beam training feedback information 528 following an SIFS 526 after the last candidate beam training packet 524. In this example, the AP2 acknowledges the beam training feedback information 528 with an ACK 530. Data transfer (e.g., an exchange of data and/or management/control packets 534 and BA/ACKs 536) can then resume over the mmWave link, following a negotiated delay time 532, with a new and more robust Tx/Rx beam pair determined by the candidate beam training procedure.

FIG. 5B illustrates another example of a frame exchange sequence for a candidate beam training procedure for recovering a mm Wave link in accordance with an embodiment of the present disclosure. In the illustrated example, the AP MLD 500 and the non-AP MLD 504 correspond to the AP MLD 200 and the non-AP MLD 204 of FIG. 2A. In addition, the illustrated packet exchange sequence involving beam failure detection (data packets 508 and BAs/ACKs 510) proceed as described above with reference to FIG. 2A. In this example, the non-AP MLD 504 requests a candidate beam training procedure to be conducted over the mm Wave link, and the AP MLD 500 further requests (sequential) reverse link beam training over the mm Wave link (e.g., due to no Tx/Rx beam reciprocity and/or the reverse direction also has degradation).

In the illustrated example, the STA2 transmits a request frame 540 (for beam recovery) over the mmWave link, and a response frame 542 including a request for a reverse link CBT procedure is transmitted by AP2 to acknowledge the request frame 540. The AP2 further transmits an announcement frame 544 for the CBT procedure 550, and the STA2 responds with an announcement frame 546. In the CBT procedure 550 of this example, the AP2 transmits a plurality of candidate beam training packets 552 following a pre-defined IFS 548 (e.g., a short interframe space). Following the candidate beam training packets 552, the STA2 transmits a plurality of candidate beam training packets 554 for reception by the AP2 over the mmWave link. In this example, following the last candidate beam training packet 554, the AP2 transmits responder beam training feedback information 556 regarding the candidate beam training packets 554, and the STA2 subsequently transmits initiator beam training feedback information 558 regarding the candidate beam training packets 552. Data transfer (e.g., an exchange of data and/or management/control packets 562 and BA/ACKs 564) can then resume over the mmWave link, following a negotiated delay time 560, with a new and more robust Tx/Rx beam pair determined by the candidate beam training procedure.

FIG. 6 illustrates an example of a frame exchange sequence of a mmWave sector sweep initiated by a non-mmWave link in accordance with an embodiment of the present disclosure. In the illustrated example, the AP MLD 600 and the non-AP MLD 604 correspond to the AP MLD 200 and the non-AP MLD 204 of FIG. 2A. The illustrated frame exchange sequence of an example of mmWave sector sweep training (also referred to as sector sweep or beamforming by sector sweeping), which is generally used to determine a transmission beamforming pattern to be applied by a first wireless device when transmitting data to a second wireless device. For example, the first wireless device can transmit training packets to the second wireless device, where the first wireless device can apply a different transmission beamforming pattern when transmitting each training packet. The second device generally determines which of the training packets had the highest quality (e.g., having the highest signal-to-noise ratio (SNR) and/or the lowest bit error rate (BER) and notifies the first wireless device, which can then utilize the transmission beamforming pattern that yielded the highest quality packet. The second device may also sweep through different receive beamforming patters via the Rx TRN field of the training packet it detects or multiple training packets which have the same transmission beamforming pattern. Similarly, to determine a transmission beamforming pattern to be applied by the second device and a reception beamforming pattern to be applied by the first wireless device when receiving data from the second wireless device, the second wireless device transmits training packets to the first wireless device, and the first wireless device applies a different beamforming pattern when receiving each training packet. The first wireless device may determine which of the training packets has the highest quality, notify the second device of the corresponding transmission beamforming pattern, and utilize the corresponding reception beamforming pattern that yields the highest quality packet.

Referring more specifically to the frame exchange sequence depicted in FIG. 6, after receiving an AF 608 from AP1 of AP MLD 600, STA1 of non-AP MLD 604 responds with another AF to announce a sector sweep. Specifically, after a backoff period (i.e., a backoff counter decrements to zero), AP1 transmits an AF 608 to STA1 through the non-mm Wave link (e.g., a 5 GHz band link) between AP1 and STA1, and STA1 transmits an AF 610 to AP1 through the non-mmWave link between AP1 and STA1. AP2 (the beamformer) and STA2 (the beamformee) negotiate a delay time 612 required between the end of frame exchange of the AF 610 and the start of sounding in an mmWave link (e.g., a 60 GHz band link) between AP2 and STA2. The negotiated time and the end time of NDPA frame exchange determines when the sounding in the mmWave link begins. In other examples, the mmWave sounding announcement handshake and timing negotiations may include an RTS/CTS/NDPA frame exchange, an NDPA/ACK frame exchange, etc.

In some embodiments, an updated null data packet announcement (NDPA) is used for the mmWave sounding and indicates whether the sounding is done through cross-link or not. In some embodiments, a special STA information field is defined to indicate whether the cross-link sounding is requested or not, and the link ID of the mmWave link in the cross-link sounding is requested. The link ID may be used since an MLD may include more than one mmWave link. In some embodiments, in a (redesigned) STA Info field, one reserved bit is used to indicate the cross-link sounding announcement. The sector number being trained can be announced in NDPA or in a mmWave link's capabilities element. In some embodiments, a new control frame is defined for Ultra High Reliability (UHR) NDPA of cross-link sounding.

In the illustrated example, the sector sweep stage includes two-direction sector sweep. In other examples, the sector sweep is in one direction (e.g., only Tx beams or Rx beams are swept). Negotiations between AP MLD 600 and non-AP MLD 604 may determine whether the sector sweep is a two-direction sector sweep or a one-direction sector sweep. In the embodiment depicted in FIG. 6, after the delay time 612, a sector sweep 614 with a number of training sequences 616-1, . . . , 616-N, where N is a positive integer, is communicated or conducted from AP2 to STA2 through the mmWave link (e.g., a 60 GHz band link) between AP2 and STA2. Subsequently, a sector sweep 618 with a number of training sequences 620-1, . . . , 620-M, where M is a positive integer, is communicated or conducted from STA2 to AP2 through the mmWave link (e.g., a 60 GHz band link) between AP2 and STA2. In various examples, the sector sweep 614 and/or sector sweep 618 may be utilized to establish a mmWave link, reestablish a mmWave link, or as part of a candidate beam training procedure.

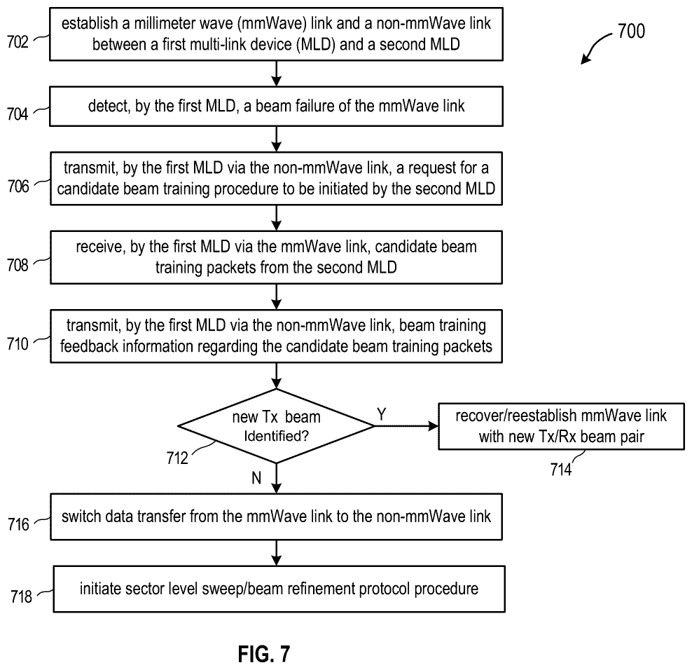

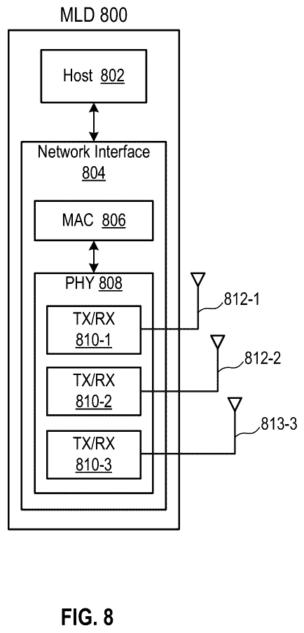

FIG. 7 is a logic diagram illustrating an example process 700 for mmWave link beam recovery in accordance with embodiments of the present disclosure. The process 700 can be performed by a non-AP MLD, such as the non-AP MLD 204 described with reference to FIG. 2A or the MLD 800 described with reference to FIG. 8. The process 700 may be utilized to recover or reestablish a mmWave link with an AP MLD, such as the AP MLD 200 described with reference to FIG. 2A. Alternatively, the process 700 can be initiated by an AP MLD if the beam failure of mmWave link is detected at its receiver.

The illustrated method begins at step 702 where a millimeter wave (mmWave) link and a non-mmWave link are established between a first MLD (e.g., a non-AP MLD) and a second MLD (e.g., an AP MLD). The method continues at step 704, where the first MLD detects a beam failure of the mm Wave link. In an example, detecting a beam failure of the mm Wave link includes receiving a plurality of packets from the second wireless MLD over the mmWave link, comparing a received signal strength of each of the plurality of packets to a predetermined threshold, and determining that consecutive packets of the plurality of packets have a received signal strength that is less than the predetermined threshold. In another example, detecting a beam failure of the mmWave link includes receiving a plurality of packets from the second wireless MLD over the mmWave link and determining that consecutive packets of the plurality of packets have a received signal strength, relative to a preceding packet of the plurality of packets, that is less than a predetermined threshold.

The method continues at step 706, where the first MLD transmits, via the non-mmWave link, a request for a candidate beam training procedure to be initiated by the second MLD. In an example, the request for a candidate beam training procedure is carried in a request frame for beam recovery. In response to the request, the first MLD may receive, via the non-mmWave link, a response frame to acknowledge the beam recovery request. In this example, the first MLD may then receive an announcement frame from the second MLD, via the non-mmWave link, and transmit, via the non-mmWave link, an acknowledgement to the second MLD. The method continues at step 708, where the first MLD receives candidate beam training packets from the second MLD over the mmWave link. In a further example in which the second MLD requests candidate beam training for the reverse direction of the mmWave link, the first MLD may transmit candidate beam training packets to the second MLD over the mmWave link (e.g., as described with reference to FIGS. 2B and 2C).

The first MLD next transmits (at step 708) beam training feedback information regarding the candidate beam training packets to the second MLD via the non-mmWave link. In an example, the beam training feedback information includes an indication of a Tx beam with a highest received signal strength. If a suitable Tx beam is identified by the candidate beam training procedure as determined at step 712, the first MLD and second MLD recover (or reestablish) the mmWave link using the new Tx beam in a new Tx/Rx beam pair, and normal data communications may resume over the mm Wave link.

If a suitable Tx beam is not identified as determined at step 712, data transfer over the mm Wave link is switched (step 716) to a non-mm Wave link between the first MLD and the second MLD. The method may continue at 718, where the first MLD or the second MLD initiates a comprehensive beam training procedure including sector level sweep and beam refinement protocols. In an example, the first MLD receives, over the non-mmWave link, an acknowledgement from the second MLD in response to the beam training feedback information, the acknowledgment including an indication to switch data transfer from the mmWave link to a non-mm Wave link. In another example, the beam training feedback information includes a request to switch to the non-mmWave link and/or initiate a new comprehensive training procedure including sector level sweep and beam refinement protocols to reestablish the mmWave link. In this example, the first MLD may determine to request the switch and/or comprehensive beam training procedure after performing an analysis of the received candidate beam training packets. The analysis may include, for example, identifying one or more packets of the candidate beam training packets having a highest received signal strength, comparing the highest received signal strength to a predetermined threshold, and determining that the highest received signal strength is less than the predetermined threshold.

FIG. 8 illustrates an example of a wireless multi-link device (MLD) 800 according to an embodiment of the present disclosure. The MLD 800 is configurable (e.g., as an AP MLD or non-AP MLD) to perform a mmWave link beam failure recovery procedure according to any of the various embodiments described herein. The illustrated MLD 800 includes a host processor 802 coupled to a network interface device 804. The network interface device 804 includes a medium access control (MAC) processing unit 806 and a physical layer (PHY) processing unit 808. The PHY processing unit 808 includes a plurality of transceivers 810 coupled to a plurality of antennas 812. Although three transceivers 810 (810-1, 810-2 and 810-3) and three antennas 812 (812-1, 812-2 and 812-3) are illustrated in FIG. 1, the MLD 800 includes other suitable numbers (e.g., 1, 2, 4, 5, etc.) of transceivers 810 and antennas 812 in other embodiments. In an example, the MAC processing unit 806 and the PHY processing unit 808 are configured to operate in compliance with the IEEE 802.11bn amendment to the IEEE 802.11 standard. In an example, the network interface device 804 includes one or more integrated circuit (IC) devices. In this example, at least some of the functionality of the MAC processing unit 806 and at least some of the functionality of the PHY processing unit 808 can be implemented on a single IC device. As another example, at least some of the functionality of the MAC processing unit 806 is implemented on a first IC device, and at least some of the functionality of the PHY processing unit 808 is implemented on a second IC device. The MLD 800 may communicate with a plurality of (MLD) client stations (not separately illustrated), including both legacy and non-legacy client stations.

In various embodiments, the PHY processing unit 808 of the MLD 800 is configured to generate data units conforming to a non-legacy communication protocol and having formats described herein. The transceiver(s) 810 is/are configured to transmit the generated data units via the antenna(s) 812. Similarly, the transceiver(s) 810 is/are configured to receive data units via the antenna(s) 812. The PHY processing unit 808 of the MLD 800 is configured to process received data units conforming to the non-legacy communication protocol and having formats described herein and to determine that such data units conform to the non-legacy communication protocol.

In an embodiment, when operating in single-user mode, the MLD 800 transmits a data unit to a single client station (DL SU transmission), or receives a data unit transmitted by a single client station (UL SU transmission), without simultaneous transmission to, or by, any other client station. When operating in multi-user mode, the MLD 800 transmits a data unit that includes multiple data streams for multiple client stations (DL MU transmission), or receives data units simultaneously transmitted by multiple client stations (UL MU transmission). For example, in multi-user mode, a data unit transmitted by the MLD includes multiple data streams simultaneously transmitted by the MLD 800 to respective client stations using respective spatial streams allocated for simultaneous transmission to the respective client stations and/or using respective sets of OFDM tones corresponding to respective frequency sub-channels allocated for simultaneous transmission to the respective client stations. In a further example, the MLD 800 may be configured as a multi-link device, such as the AP MLD 102 or STA MLD 104-1 described above with reference to FIG. 1 or the AP MLD 200 or non-AP MLD 204 described above with reference to FIG. 2A.

In an example, the MLD 800 is configured to generate control or management information regarding a millimeter wave (mmWave) link between the MLD 800 and a second MLD, and the transceiver(s) 810 is/are configured to transmit the control or management information to the second MLD through the mmWave link or through a non-mmWave link between the MLD 800 and the second MLD. In some embodiments, the non-mmWave link includes one of a 2.4 Gigahertz (GHz) link, a 5 GHz link, or a 6 GHz link, and the mmWave link includes a 45 GHz link or a 60 GHz link.

In some embodiments, the MLD 800 is further configured to generate a broadcast frame that contains the control or management information regarding the mmWave link, and the transceiver(s) 810 is/are further configured to transmit the broadcast frame to the second MLD through the non-mmWave link. In some embodiments, the control or management information regarding the mmWave link includes link connection establishment information regarding the mmWave link. In some embodiments, the control or management information regarding the mmWave link includes mmWave sounding announcement information regarding the mmWave link that initiates a sector sweep training between the MLD 800 and the second MLD. In some embodiments, the mmWave sounding announcement information regarding the mmWave link includes a null data packet announcement (NDPA) or a request to send (RTS). In some embodiments, the transceiver(s) 810 is/are further configured to transmit the control or management information regarding the mmWave link to the second MLD through the mmWave link between the MLD 800 and the second MLD. In some embodiments, the control or management information regarding the mmWave link includes a measurement related frame for the mm Wave link. In some embodiments, the MLD 800 is further configured to generate a unicast frame that contains the control or management information regarding the mmWave link, and the transceiver(s) 810 is/are further configured to transmit the unicast frame through the mmWave link.

While the innovate aspects of the present disclosure have been generally described in the context of the 802.11bn amendment, and future generations, of the IEEE 802.11 standard, a person having ordinary skill in the art will readily recognize that teachings herein may be applied to other wireless networks and standards including, for example, cellular network standards and Bluetooth standards.

The innovative methods and apparatus illustrated in the drawings and described herein provide for mmWave link beam failure recovery procedures. In an illustrative, non-limiting embodiment, a method for wireless communication by a wireless multi-link device (MLD) is provided. The method includes establishing a mmWave link and a non-mmWave link with a second wireless MLD. The method further includes detecting a beam failure of the mm Wave link and transmitting, via the non-mmWave link, a request frame for a candidate beam training procedure to be initiated by the second wireless MLD. In response to the request frame, the method further includes receiving, by the wireless MLD via the non-mmWave link, candidate beam training packets from the second wireless MLD. The method further includes transmitting, via the non-mmWave link, beam training feedback information regarding the candidate beam training packets. Based on the beam training feedback information, the method further includes maintain the mm Wave link or switching to the non-mmWave link.

The method of this embodiment includes optional aspects. With one optional aspect, detecting a beam failure of the mmWave link includes receiving a plurality of packets from the second wireless MLD over the mmWave link, comparing a received signal strength of each of the plurality of packets to a predetermined threshold, and determining that consecutive packets of the plurality of packets have a received signal strength that is less than the predetermined threshold. In another optional aspect, detecting a beam failure of the mmWave link includes receiving a plurality of packets from the second wireless MLD over the mmWave link and determining that consecutive packets of the plurality of packets have a received signal strength, relative to a preceding packet of the plurality of packets, that is less than a predetermined threshold.

In another optional aspect, the method further includes receiving, via the non-mmWave link, a response frame from the second wireless MLD to confirm the request frame for a candidate beam training procedure. The method of this optional aspect further includes receiving, via the non-mmWave link, an announcement frame from the second wireless MLD to initiate a candidate beam training procedure, and transmitting, via the non-mmWave link, an acknowledgement frame for the announcement frame. With another optional aspect, the announcement frame includes a number of transmit (Tx) beams. In this optional aspect, the acknowledgement indicates whether Rx beam training is required and, if Rx beam training is required, a number of receive (Rx) beams.

In another optional aspect, the candidate beam training procedure utilizes one or more of up to a max number of receive (Rx) beams advertised in a mmWave link capabilities clement transmitted by the wireless MLD, or up to a max number of transmit (Tx) beams advertised in a mmWave link capabilities element received by the wireless MLD from the second wireless MLD. With yet another optional aspect, the beam training feedback information includes at least one of an indication of a Tx beam with a highest received signal strength or a ranking of candidate Tx beams based on received signal strength.

In yet another optional aspect, the method further includes identifying one or more packets of the candidate beam training packets having a highest received signal strength and comparing the highest received signal strength to a predetermined threshold. The method further includes determining that the highest received signal strength is less than the predetermined threshold. In this optional aspect, the beam training feedback information regarding the candidate beam training packets includes at least one of a request to switch data transfer from the mm Wave link to the non-mm Wave link or a request for a new beam training procedure that includes a sector level sweep procedure.

In still another optional aspect, the method further includes receiving, over the non-mmWave link, an acknowledgement from the second wireless MLD in response to the beam training feedback information. The acknowledgment includes an indication to switch data transfer from the mm Wave link to the non-mm Wave link. With another optional aspect, the request frame for a candidate beam training procedure includes an indication of at least one candidate Tx beam based on a previous beam training report or feedback, and the method further includes receiving, via the non-mmWave link, a response frame to confirm receipt of the request frame and including a request for reverse direction candidate beam training. In this optional aspect, the method further includes transmitting, via the non-mmWave link, an announcement frame for the reverse direction candidate beam training and transmitting, via the mmWave link, second candidate beam training packets following receipt of the candidate beam training packets from the second wireless MLD. In a further optional aspect, the non-mmWave link comprises a 2.4 GHz link, a 5 GHz link or a 6 GHz link, and wherein the mmWave link comprises a 45 GHz link or a 60 GHz link.

With another illustrative, non-limiting embodiment, a wireless multi-link device (MLD) includes a plurality of wireless transceivers, memory including operational instructions, and one or more processing modules operably coupled to the plurality of wireless transceivers and the memory. The one or more processing modules are configured to execute the operational instructions to establish, via the plurality of wireless transceivers, a millimeter wave (mmWave) link and a non-mmWave link with a second wireless MLD. The one or more processing modules are further configured to execute the operational instructions to detect a beam failure of the mmWave link and transmit, over the non-mmWave link, a request frame for a candidate beam training procedure to be initiated by the second wireless MLD. The one or more processing modules are further configured to execute the operational instructions to receive, over the mmWave link, candidate beam training packets from the second wireless MLD, transmit, over the non-mmWave link, beam training feedback information regarding the candidate beam training packets, and maintain the mmWave link or switch to the non-mmWave link based on the beam training feedback information.

This embodiment includes optional aspects. With one optional aspect, detecting a beam failure of the mm Wave link includes receiving, over the mmWave link, a plurality of packets from the second wireless MLD, comparing a received signal strength of each of the plurality of packets to a predetermined threshold, and determining that consecutive packets of the plurality of packets have a received signal strength that is less than the predetermined threshold. In another optional aspect, detecting a beam failure of the mmWave link includes receiving, over the mmWave link, a plurality of packets from the second wireless MLD and determining that consecutive packets of the plurality of packets have a received signal strength, relative to a preceding packet of the plurality of packets, that is less than a predetermined threshold.

In another optional aspect, the one or more processing modules are further configured to execute the operational instructions to receive, over the non-mmWave link, a response frame from the second wireless MLD to confirm the request frame for a candidate beam training procedure. In this optional aspect, the one or more processing modules are further configured to execute the operational instructions to receive, over the non-mmWave link, an announcement frame from the second wireless MLD to initiate the candidate beam training procedure, and transmit, over the non-mmWave link, an acknowledgement frame for the announcement frame. With another optional aspect, the non-mmWave link comprises a 2.4 GHz link, a 5 GHz link or a 6 GHz link, and the mmWave link comprises a 45 GHz link or a 60 GHz link. In yet another optional aspect, the wireless MLD is a non-AP MLD and the second wireless MLD is an AP-MLD.

With another illustrative, non-limiting embodiment, a method for wireless communication is provided. The method includes establishing a millimeter wave (mmWave) link and a non-mmWave link between a first MLD and a second MLD. The method further includes detecting, by the second MLD, a beam failure of the mm Wave link and transmitting, by the second MLD via the non-mmWave link, a request frame for a candidate beam training procedure to be initiated by the first MLD. The method continues with initiating, by the first MLD via the non-mmWave link, a candidate beam training procedure for the mmWave link in response to the request frame for a candidate beam training procedure, and receiving, by the second MLD via the mmWave link, candidate beam training packets from the second MLD. The method further includes transmitting, by the second MLD via the non-mmWave link, beam training feedback information regarding the candidate beam training packets. Based on the beam training feedback information, the method further includes maintain the mmWave link or switching to the non-mmWave link.

The method of this embodiment includes optional aspects. With one optional aspect, detecting a beam failure of the mmWave link includes receiving a plurality of packets from the second wireless MLD over the mmWave link, comparing a received signal strength of each of the plurality of packets to a predetermined threshold, and determining that consecutive packets of the plurality of packets have a received signal strength that is less than the predetermined threshold. In another optional aspect, detecting a beam failure of the mmWave link includes receiving a plurality of packets from the second wireless MLD over the mmWave link and determining that consecutive packets of the plurality of packets have a received signal strength, relative to a preceding packet of the plurality of packets, that is less than a predetermined threshold.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a processing core, processing circuitry, computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

As may be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may further be used herein, the term(s) “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processor”, “processing circuitry”, “processing circuit”, “processing module”, and/or “processing unit” may be a single processing device or a plurality of processing devices. Such a processing device may be a microprocessor, microcontroller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Further, such a processing device may include a plurality of processing cores or processing domains, which may operate on separate power domains. The processor, processing circuitry, processing circuit, processing module, and/or processing unit may be (or may further include) memory and/or an integrated memory element, which may be a single memory device, a plurality of memory devices, and/or embedded circuitry of another processor, processing circuitry, processing circuit, processing module, and/or processing unit. Such a memory device may be a read-only memory, random access memory, volatile memory, non-volatile memory, static memory, dynamic memory, flash memory, cache memory, and/or any device that stores digital information. Note that if the processor, processing circuitry, processing circuit, processing module, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processor, processing circuitry, processing circuit, processing module, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processor, processing circuitry, processing circuit, processing module, and/or processing unit executes, hard coded and/or operational instructions corresponding to at least some of the steps and/or functions illustrated in one or more of the figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the logic diagram block boundaries and sequence could have been defined otherwise and still perform the certain significant functionality. Such alternate definitions of both functional building blocks and logic diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors/processing cores executing appropriate software and the like or any combination thereof.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” may be used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for wireless communication by a wireless multi-link device (MLD), comprising:
establishing a millimeter wave (mmWave) link and a non-mmWave link with a second wireless MLD;
detecting a beam failure of the mmWave link;
transmitting, via the non-mmWave link, a request frame for a candidate beam training procedure to be initiated by the second wireless MLD;
receiving, via the mmWave link, candidate beam training packets from the second wireless MLD;
transmitting, via the non-mmWave link, beam training feedback information regarding the candidate beam training packets; and
maintaining the mmWave link or switching to the non-mmWave link based on the beam training feedback information.

2. The method of claim 1, wherein detecting a beam failure of the mmWave link includes:
receiving a plurality of packets from the second wireless MLD over the mmWave link;
comparing a received signal strength of each of the plurality of packets to a predetermined threshold; and
determining that consecutive packets of the plurality of packets have a received signal strength that is less than the predetermined threshold.

3. The method of claim 1, wherein detecting a beam failure of the mmWave link includes:
receiving a plurality of packets from the second wireless MLD over the mmWave link; and
determining that consecutive packets of the plurality of packets have a received signal strength, relative to a preceding packet of the plurality of packets, that is less than a predetermined threshold.

4. The method of claim 1, further comprising:
receiving, via the non-mmWave link, a response frame from the second wireless MLD to confirm the request frame for a candidate beam training procedure;
receiving, via the non-mmWave link, an announcement frame from the second wireless MLD to initiate the candidate beam training procedure; and
transmitting, via the non-mmWave link, an acknowledgement frame for the announcement frame.

5. The method of claim 4, wherein the announcement frame includes a number of transmit (Tx) beams, and wherein the acknowledgement frame indicates whether Rx beam training is required and, if Rx beam training is required, a number of receive (Rx) beams.

6. The method of claim 1, wherein the candidate beam training procedure utilizes at least one of:
up to a max number of receive (Rx) beams advertised in a mmWave link capabilities element transmitted by the wireless MLD; or
up to a max number of transmit (Tx) beams advertised in a mmWave link capabilities element received by the wireless MLD from the second wireless MLD.

7. The method of claim 1, wherein the beam training feedback information includes at least one of an indication of a Tx beam with a highest received signal strength or a ranking of candidate Tx beams based on received signal strength.

8. The method of claim 1, further comprising:
identifying one or more packets of the candidate beam training packets having a highest received signal strength;
comparing the highest received signal strength to a predetermined threshold; and
determining that the highest received signal strength is less than the predetermined threshold, wherein the beam training feedback information regarding the candidate beam training packets includes at least one of:
a request to switch data transfer from the mmWave link to the non-mmWave link; or
a request for a new beam training procedure that includes a sector level sweep procedure.

9. The method of claim 8, further comprising:
receiving, over the non-mmWave link, an acknowledgement from the second wireless MLD in response to the beam training feedback information, the acknowledgment including an indication to switch data transfer from the mmWave link to the non-mm Wave link.

10. The method of claim 1, wherein the request frame for a candidate beam training procedure includes an indication of at least one candidate Tx beam based on a previous beam training report or feedback, the method further comprising:
receiving, via the non-mmWave link, a response frame to confirm receipt of the request frame, the response frame including a request for reverse direction candidate beam training;
transmitting, via the non-mmWave link, an announcement frame for the reverse direction candidate beam training; and
transmitting, via the mmWave link, second candidate beam training packets following receipt of the candidate beam training packets from the second wireless MLD.

11. The method of claim 1, wherein the non-mmWave link comprises a 2.4 GHz link, a 5 GHz link or a 6 GHz link, and wherein the mmWave link comprises a 45 GHz link or a 60 GHz link.

12. A wireless multi-link device (MLD) comprising:
a plurality of wireless transceivers;
memory including operational instructions; and
one or more processing modules operably coupled to the plurality of wireless transceivers and the memory, wherein the one or more processing modules are configured to execute the operational instructions to:
establish, via the plurality of wireless transceivers, a millimeter wave (mmWave) link and a non-mmWave link with a second wireless MLD;
detect a beam failure of the mmWave link;
transmit, over the non-mmWave link, a request frame for a candidate beam training procedure to be initiated by the second wireless MLD;
receive, over the mmWave link, candidate beam training packets from the second wireless MLD;
transmit, over the non-mmWave link, beam training feedback information regarding the candidate beam training packets; and
maintain the mmWave link or switch to the non-mmWave link based on the beam training feedback information.

13. The wireless MLD of claim 12, wherein detecting a beam failure of the mmWave link includes:
receiving, over the mmWave link, a plurality of packets from the second wireless MLD;
comparing a received signal strength of each of the plurality of packets to a predetermined threshold; and
determining that consecutive packets of the plurality of packets have a received signal strength that is less than the predetermined threshold.

14. The wireless MLD of claim 12, wherein detecting a beam failure of the mmWave link includes:
receiving, over the mmWave link, a plurality of packets from the second wireless MLD; and
determining that consecutive packets of the plurality of packets have a received signal strength, relative to a preceding packet of the plurality of packets, that is less than a predetermined threshold.

15. The wireless MLD of claim 12, wherein the one or more processing modules are further configured to execute the operational instructions to:
receive, over the non-mmWave link, a response frame from the second wireless MLD to confirm the request frame for a candidate beam training procedure;
receive, over the non-mmWave link, an announcement frame from the second wireless MLD to initiate the candidate beam training procedure; and
transmit, over the non-mmWave link, an acknowledgement frame for the announcement frame.

16. The wireless MLD of claim 12, wherein the non-mmWave link comprises a 2.4 GHz link, a 5 GHz link or a 6 GHz link, and wherein the mmWave link comprises a 45 GHz link or a 60 GHz link.

17. The wireless MLD of claim 12, wherein the wireless MLD is a non-AP MLD and the second wireless MLD is an AP-MLD.

18. A method for wireless communication, comprising:
establishing a millimeter wave (mmWave) link between a first MLD and a second MLD;
establishing a non-mmWave link between the first MLD and the second MLD;
detecting, by the second MLD, a beam failure of the mmWave link;
transmitting, by the second MLD via the non-mmWave link, a request frame for a candidate beam training procedure to be initiated by the first MLD;
initiating, by the first MLD via the non-mmWave link, a candidate beam training procedure for the mmWave link in response to the request frame for a candidate beam training procedure;
receiving, by the second MLD via the mmWave link, candidate beam training packets from the second MLD;
transmitting, by the second MLD via the non-mmWave link, beam training feedback information regarding the candidate beam training packets; and
maintaining the mmWave link or switching to the non-mmWave link based on the beam training feedback information.

19. The method of claim 18, wherein detecting a beam failure of the mmWave link by the second MLD includes:
receiving a plurality of packets from the first MLD over the mmWave link;
comparing a received signal strength of each of the plurality of packets to a predetermined threshold; and
determining that consecutive packets of the plurality of packets have a received signal strength that is less than the predetermined threshold.

20. The method of claim 18, wherein detecting a beam failure of the mmWave link by the second MLD includes:
receiving a plurality of packets from the first MLD over the mmWave link; and
determining that consecutive packets of the plurality of packets have a received signal strength, relative to a preceding packet of the plurality of packets, that is less than a predetermined threshold.
